(19) United States
(12) Patent Application Publication
(10) Pub. No.: US 2003/0077205 A1
(43) Pub. Date: Apr. 24, 2003

(54) Diagnostic test optical fiber tips

(76) Inventor: Tom C. Xu, Castro Valley, CA (US)

Correspondence Address: Tom C. Xu, 21010 Sherman Drive, Castra Valley, CA, 94552, US

(21) Appl. No.: 10/038,263

(22) Filed: Oct. 24, 2001

(51) Int. Cl. G01N 21/17

(52) U.S. Cl. 422/82.11; 422/82.05; 422/82.09; 422/55; 422/56; 436/164; 436/165; 436/169; 385/12

(57) ABSTRACT

A fiber optic sensor system is provided to determine the concentration of an analyte in fluids. The sensor is made of an optical fiber tip or a tubular tip and has a working end coated with reagents and enzymes. When the working end of the test tip interacts with the analyte, a color reaction takes place. The color intensity is correlated with the amount of analyte presented in the sample and will be transmitted through the optical fiber to a reading meter for data processing. The system can be used to monitor the concentration of a biological analyte such as glucose in blood. Because of the high sensitivity of the fiber optical detection system described here, a minimal sample volume is required and a virtually painless testing process can be achieved.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to diagnostic test optical fiber tips for detection and quantification of analytes of interest in biological fluids.

Dry reagent test strips as biological sensors are widely used in the quantification of biological components in body fluids. One major application of these sensors is in the blood glucose self-monitoring testing by diabetic patients. Diabetic patients test their blood glucose level daily in order to attain better control over their diets and medication. A large-scale study conducted by the National Institutes of Health revealed that long-term tight control of the blood glucose levels in patients had a direct relationship to the health of the patient. It is recommended that most individuals with diabetes should attempt to achieve and maintain blood glucose levels as close to normal as is safely possible. Particularly for patients with Type 1 diabetes, they can achieve this goal only by self-monitoring of blood glucose.

Many diabetic patients are currently using a blood glucose self-monitoring system disclosed by Phillips et al in U.S. Pat. Nos. 4,935,346, 5,049,487, 5,059,394, 5,179,005 and 5,304,468. The system includes a hand-held meter, disposable test strips and a lancing blood sampling device. To perform the test, the patients lance their fingers and apply a drop of blood sample to the test strip. The test strip, impregnated by necessary chemicals and enzymes, functions as a biosensor which changes its color when contacted with the sample. The meter measures the color change which correlates to the blood glucose level in the sample and then reports the test result on its digital display screen.

U.S. Pat. Nos. 5,296,192 and 6,040,195 to Carroll et al described an improved multi-layered diagnostic test strip for receiving a whole blood sample for diagnostic testing. The test strip includes filtration layers to remove red blood cells, fluid volume control dams to prevent spillage of the fluid from the strip, and a chemical reagent formulation that facilitates end-point testing.

Douglas et al in U.S. Pat. No. 6,099,484 disclosed a test strip affixed to an end of a capillary tube for receiving fluid samples. An absorbent pad is disposed between the test strip and capillary tube for spreading-out the fluid being transferred to the test strip. An on-site analyzer such as an optical analyzer and/or an electrochemical analyzer can be mounted in the device for analyzing the fluid.

While the above methods are all currently being used by diabetic patients, they share some common limitations.

First of all, since these methods use strips as the sensing part to carry out the color reaction, a relatively large volume of blood, normally from 3 uL to 50 uL, is required to cover the strip test area; therefore, patients either have to lance their fingers to obtain such an amount of blood, or have to use a special massaging sampling device to get enough blood from arms or thighs. Apparently these are either painful or unpleasant procedures. Many people with diabetes do not test their blood sugar at all or do not test often enough because the pain associated with testing is a major concern to them. They would test or test more often if testing was less painful or painless.

Secondly, since the analyte of interest is measured by the light signal reflected off the surface of a test strip where a color reaction has taken place, the strip has to be inserted into the shroud of the meter during test to avoid interference from environmental lights. This also requires that the surface of the test strip be closely placed near the light source and the light detector of the meter. Repeated testing could potentially result in contamination of the meter by blood or other biological fluids and lead to inaccurate test results.

Thirdly, most of the current test strips are designed for using fingertip blood samples, unsuitable for either arm or thigh blood because of the restricted accessibility from these parts of the body to the sample area on the strip. Although this problem has been tackled in U.S. Pat. No. 6,099,484 to Douglas et al by using a capillary device as a wick to transfer the fluid sample to the strip pad, adding an extra capillary device makes the test strip more complicated and also increases the cost.

To overcome these limitations, it is desirable to develop a testing system that requires a minimal sample volume, eliminates contamination to meters and is capable of using not only fingertip blood samples but also blood samples from other parts of body, such as the arm and thigh, which have a lower nerve ending density making the sampling process less painful or even painless.

Over the past two decades, a wide variety of optical chemical sensors have been proposed for analysis of chemical species in industrial, environmental and biological samples. These sensors operate by detecting optical changes of a sensing material or indicator dye on interaction with an analyte. Due to the variety of analyte-specific indicators available, such sensors may be used for monitoring a large number of analytes, including blood glucose testing for diabetics.

For example, U.S. Pat. No. 5,859,937 to Nomura disclosed a sensor comprising an atomic oxygen etched optical fiber with analyte-responsive reagents deposited on the etched surface. The analyte concentration was measured by physical or chemical response upon being contacted with the reagents. However, optical fiber surface etching described in the patent is not practical for making reproducible and reliable test sensors.

Raskas in U.S. Pat. No. 6,157,442 described a micro optical fiber sensor device, but it is only for in vivo use.

The present invention provides a disposable optical fiber test tip sensor system that is easy to make and simple to use for analyzing nanoliter-scale biological samples. This invention makes blood glucose testing for diabetics much less invasive and almost painless.

### BRIEF SUMMARY OF THE INVENTION

This invention overcomes the deficiencies of the prior art by using fiber optical test tips instead of the classical paper strips as biosensors for blood glucose self-monitoring testing. With this invention, an analytical color reaction takes place at the end of an optical fiber or a micro tubular tip instead of on the surface of a test strip. Because of the high efficiency of fiber optical system in light conduction, the color change signal from the reaction end of the tip can be effectively transmitted to the other end of the tip that is connected to the light detector of a meter. The unique design of the tips significantly reduces the sample volume required for testing. The protruding nature of the tip geometry makes it possible for the tip end to reach any part of the body to fetch a blood sample. This combination of requiring a smaller sample volume and the ease with which the sample can be taken from any part of the body makes the daily frequent testing much less painful to the patients. And since the color reaction between the analyte and the reagent pad takes place at the far end of the tip relative to the meter, contamination of the meter is no longer a problem.

### BRIEF DESCRIPTION OF THE DRAWINGS

FIG. 1 illustrates the diagnostic test optical fiber in communication with a test meter.

FIG. 2 is a perspective view of one embodiment of the diagnostic test optical fiber comprised of an optical fiber and a test pad.

FIG. 3A illustrates a ball-point-pen type test meter with an optical probe retracted into the body of the pen.

FIG. 3B illustrates the pen meter with the optical probe projected outside the pen. Next to the pen meter is a tubular test tip.

FIG. 3C illustrates the pen meter in communication with the test tip mounted around the optical probe.

FIG. 4 is a perspective view of one embodiment of the diagnostic test tip comprised of a tubular tip and a test pad.

### DETAILED DESCRIPTION OF THE INVENTION

The current invention is an optical fiber test system used for the detection and quantification of an analyte of interest in liquid samples. One embodiment of the current invention comprises of a test meter (10) and a disposable diagnostic test optical fiber (20).

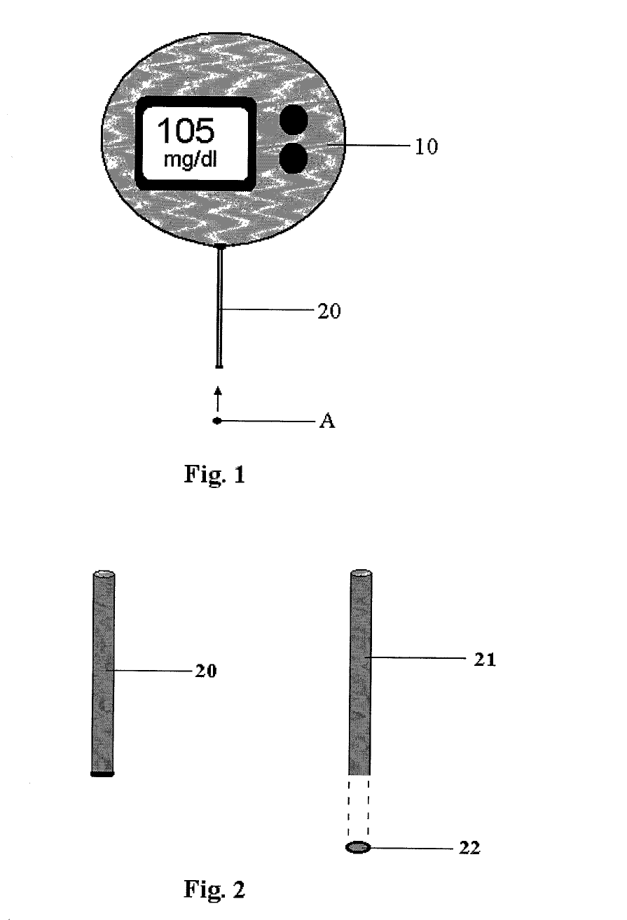

FIG. 1 depicts meter 10 in operational position in communication with test fiber 20. In a preferred use, the sample is whole blood. When blood sample “A” contacts with the reagent pad on the end of the fiber, a color reaction takes place. The color change on the pad correlates with the concentration of the analyte in the sample. The photo detection system of the meter reads the reflected light through the optical fiber from the reaction pad. The micro processing system of the meter converts the light signal into the concentration of the analyte. The result is displayed by the digital display system. The photo detection system has at least one light emitter or laser emitter, particularly an LED light or LED laser emitter. Construction of such a meter is well known in the art and needs no further description here.

As shown in FIG. 2, test fiber 20 comprises an optical fiber (21) and a reagent pad (22). The optical fiber can have a diameter from 0.01 mm to 5.00 mm, either a single fiber or a fiber bundle. The fiber can be made of glass, or plastic, or a combination of glass and plastic. The length of the fiber can vary depending on application. In one preferred embodiment, the length is from 0.1 cm to 100 cm. In a more preferred embodiment, a fiber with a diameter of 1.5 mm is cut to 2 cm long. Both ends of the optical fiber are polished before assembled with the reagent pad.

In another embodiment of the invention, the system comprises of a fiber optical meter (30) and a disposable micro tubular test tip (40).

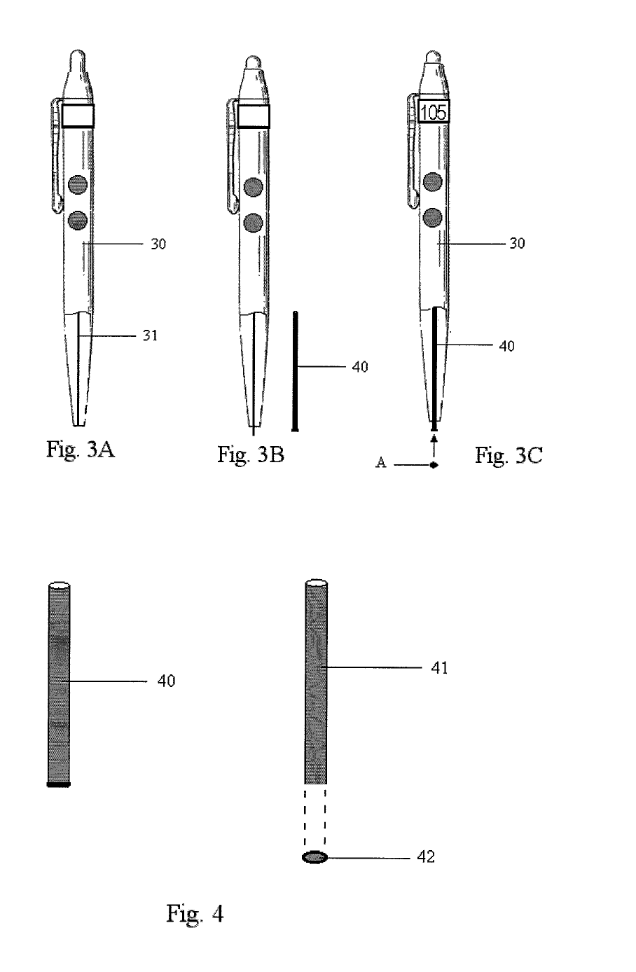

FIG. 3C depicts meter 30 in operational position in communication with test tip 40.

To facilitate use of the tubular test tips, one preferred design of the meter is in a ball-point-pen shape with a retractable optical probe. As shown in FIG. 3A, when not in use, the delicate optical probe is retracted inside the meter body to avoid damage or contamination. FIG. 3B shows that the optical probe has been projected ready to accept the tubular tip for test.

As shown in FIG. 4, test tip 40 comprises a tubular tip (41) and a reagent pad (42). In a more preferred embodiment, a plastic tubular tip with a diameter of 1-2 mm is cut to 2 cm long. One end of the tip is assembled with the reagent pad.

The reagent pad is a uniformly porous membrane impregnated with dried chemicals and enzymes required by the specific test of the interested analyte. Most commercially available hydrophilic membranes, including nylon, polyester and polysulfone, will work with the current invention. To prepare the test pad, a signal producing reagent solution is first formulated. The membrane is impregnated by this solution and then dried. Many signal generating systems can be used in the invention.

When oxidase/peroxidase enzymes are utilized, the following signal producing chemicals or chemical pairs can be used: 3-methyl-2-benzothiazolinone hydrazone (MBTH) and 3-dimethylaminobenzoic acid (DMAB) [U.S. Pat. No. 5,049,487 Phillips et al.], (MBTH) and 8-anilino-1-naphthalenessulfonate (ANS) [U.S. Pat. No. 5,453,360 Yu], MBTH and 3-dimethylaminobenzoic acid (DMAB) [U.S. Pat. No. 5,049,487 Phillips et al.], sulfonated-MBTH and N-(3-sulfopropyl)aniline (HALPS) [U.S. Pat. No. 4,396,714 Maeda et al.]. An example of end-point testing in a corresponding meter using N-ethyl-N-(2-hydroxy-3-sulfopropyl)-3,5-dimethylaniline (MAOS) and 4-Aminoantipyrine is disclosed in U.S. Pat. No. 6,040,195 to Carroll et al.

The dried reagent pad is cut to the shape of a small circular shape with a diameter matching the diameter of the optical fiber or tubular tip and then mounted to one end of the fiber or tubular tip.

In another preferred embodiment of the invention, the diagnostic test optical fiber is prepared by casting the test pad on the end of the optical fiber using a polysulfone polymer casting formulation blended with all the required reagents.

In use, for fiber optical tips, one inserts the non-reagent end of the test fiber into the detection slot of the meter and then places a small drop of blood of about 0.1-0.5 uL onto the reagent pad end. For tubular tips, one mounts the non-reagent open end of the test tip onto the optical probe of the meter and then places a small drop of blood of about 0.1-0.5 uL onto the reagent pad end. The test results can be obtained in 5 to 60 seconds depending on the chemistry used.

The present invention provides significant improvements over the current test strip technology, especially in the blood glucose self-monitoring system. The advantages include, but are not limited to: (a) using a minimal sample volume, (b) enabling applying blood samples easily to the test pad from less sensitive parts of the body such as arm and thigh, (c) eliminating meter contamination, and (d) providing a low cost alternative for patients who use test strips for daily home testing because the diagnostic test fibers and tips described here are easier and cheaper to produce.

What I claim as my invention is:

1. A test tip device for measuring an analyte in a sample comprising:
a piece of optical fiber with two ends;
a reagent pad containing all the necessary chemicals and enzymes for a specified analysis;
said reagent pad being mounted to one end of said optical fiber;
a detection device comprising: (a) a light emitting source; (b) a housing for engaging the other end of said fiber to said light source; (c) a photo detector to receive light reflected off the reagent pad end of said fiber; (d) a processor to convert the light signal to the analyte concentration, and (e) a display to display the test results.

2. The device of claim 1, wherein the test tip is disposable.

3. The device of claim 1, wherein the reagent pad is a membrane impregnated with dry chemicals and enzymes.

4. The device of claim 1, wherein said reagent pad is a cast polymer which contains all the required chemicals and enzymes for a specified analysis.

5. The device of claim 1, wherein the reagent pad membrane is mounted to the end of said optical fiber by an adhesive.

6. The device of claim 1, wherein the reagent pad membrane is mounted to the end of said optical fiber by ultrasonic welding.

7. The device of claim 1, wherein said optical fiber is made of glass/glass, or plastic/plastic, or glass/plastic.

8. A tubular test tip device for measuring an analyte in a sample comprising:
a piece of micro tubing with two ends;
a reagent pad containing all the necessary chemicals and enzymes for a specified analysis;
said reagent pad being mounted to one end of said tubing;
a detection device comprising: (a) a light emitting source; (b) a fiber optic probe connected to the said light source, (c) a photo detector to receive light reflected off the reagent pad end of said tip; (d) a processor to convert the light signal to the analyte concentration, and (e) a display to display the test results.

9. The device of claim 8, wherein the test tip is disposable.

10. The device of claim 8, wherein the reagent pad is a membrane impregnated with dry chemicals and enzymes.

11. The device of claim 8, wherein the reagent pad membrane is mounted to the end of said optical tubular tip by an adhesive.

12. The device of claim 8, wherein the reagent pad membrane is mounted to the end of said tubular tip by ultrasonic welding.

13. The device of claim 8, wherein said reagent pad is a cast polymer which contains all the required chemicals and enzymes for a specified analysis.

14. The device of claim 8, wherein said fiber optic probe is made of glass/glass, or plastic/plastic, or glass/plastic.
